(19) United States
(12) Patent Application Publication
(10) Pub. No.: US 2004/0012266 A1
(43) Pub. Date: Jan. 22, 2004

(54) Uninterruptible power supply with built-in lamp

(76) Inventor: Sam Yu, Taipei Hsien (TW)

Correspondence Address: BIRCH STEWART KOLASCH & BIRCH, PO BOX 747, FALLS CHURCH, VA, 22040-0747, US

(21) Appl. No.: 10/195,416

(22) Filed: Jul. 16, 2002

(51) Int. Cl. H02J 7/34; H02J 3/32

(52) U.S. Cl. 307/66

(57) ABSTRACT

The present invention relates to an uninterruptible power supply with a built-in lamp. The invention mainly comprises of a regular power unit, a charge circuit, and a illumination unit. When the regular power source is providing electricity normally, the power is delivered to the load through the regular power unit and a battery within the charge circuit is also charged meanwhile. When the regular power source is interrupted, the load is powered by the battery while the illumination unit is activated to light the surroundings such that users are able to do some emergent operations.

### BACKGROUND OF THE INVENTION

1. Field of the Invention

The invention relates to an uninterruptible power supply; more specifically, one with a built-in lamp.

2. Background of the Invention

Computers have become an integral part of our lives. Whether it's office work or school reports, people rely on computers to get the job done. Computers also bring entertainment to gamers across the globe. As people depend on computers more and more, sudden interruptions to the work at hand become increasingly intolerable. Such interruptions caused by a power failure may lead to frustration for the user, or even worse, the loss of data and progress. Moreover, the improper shut down of the computer may affect the stability of the operating system, leading to further inconveniences.

The solutions to the above-mentioned problems are provided widely. One of the most well known solutions is the uninterruptible power supply (UPS), which provides power continuously once the regular power source ceases. Not only the UPS has been widely used as the back-up power source of servers or industrial computer-implemented systems, the reliability is also provided as a backup power supply to many PC users.

Though power continues to be delivered to the computer, one situation of inconvenience remains: during a blackout, there is no light source to provide the light necessary to perform emergency protocols. Users often need to prepare flashlights or candles before hand. Such inconveniences can be eliminated if the UPS had a built-in lamp.

### SUMMARY OF THE INVENTION

In light of the abovementioned issues, the object of the invention is to provide an UPS with a built-in lamp. Once the power absence occurs, the lamp is automatically lighted to illuminate the dark space such that the inconveniences caused by the absence of light would be eliminated.

To achieve the abovementioned object, the UPS with a built-in lamp of the present invention comprises a regular power unit, a charging unit, and an illumination unit. When the regular power source is providing electricity normally, the power is delivered to a load through the regular power unit and the battery within the charge circuit is also charged by the regular power. When the regular power disappears, the battery operates to provide power the load immediately. Meanwhile the illumination unit is also activated to light the surroundings such that users are able to do some emergency operation.

The illumination unit mentioned above comprises a detection circuit, a control circuit, a driving circuit, and a lamp. When power failure occurs, the detection circuit issues a power interruption signal to the control circuit. In response, the control circuit then issues an activation signal to the driving circuit, which then turns on the lamp.

### BRIEF DESCRIPTION OF THE DRAWINGS

These and other features, aspects and advantages of the present invention will become understood with regard to the following descriptions, appended claims and accompanying drawings in which:

FIG. 1 is the function block diagram of the functionalities of the uninterruptible power supply with built-in lamp of the present invention; and

FIG. 2 is the detailed schematic of the detection circuit in the illumination unit of the present invention.

FIG. 3 is the detailed schematic of the control circuit in the illumination unit of the present invention.

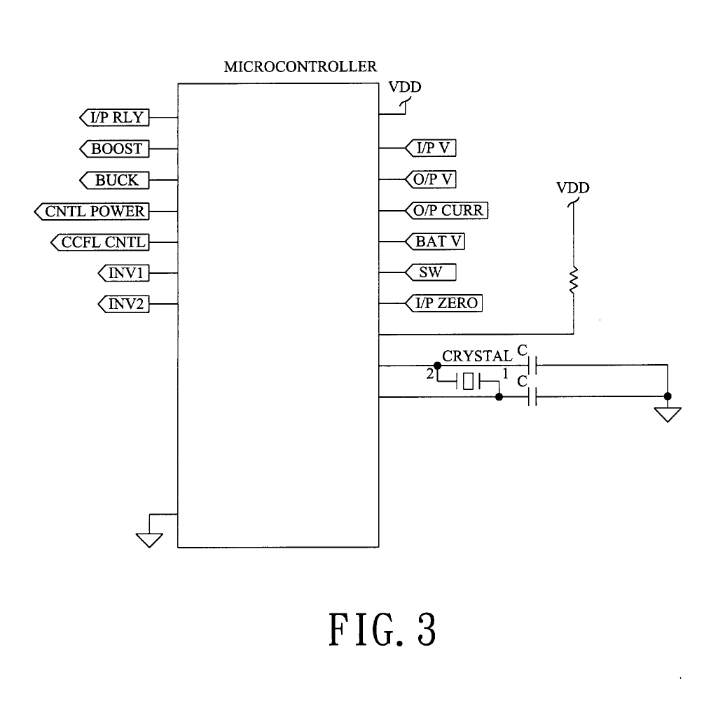

FIG. 4 is the detailed schematic of the driving circuit in the illumination unit of the present invention.

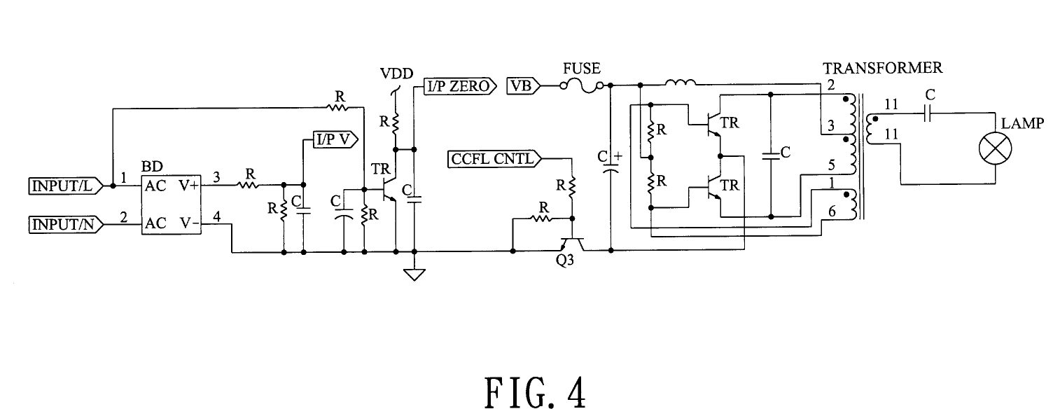

### DETAILED DESCRIPTION OF THE INVENTION

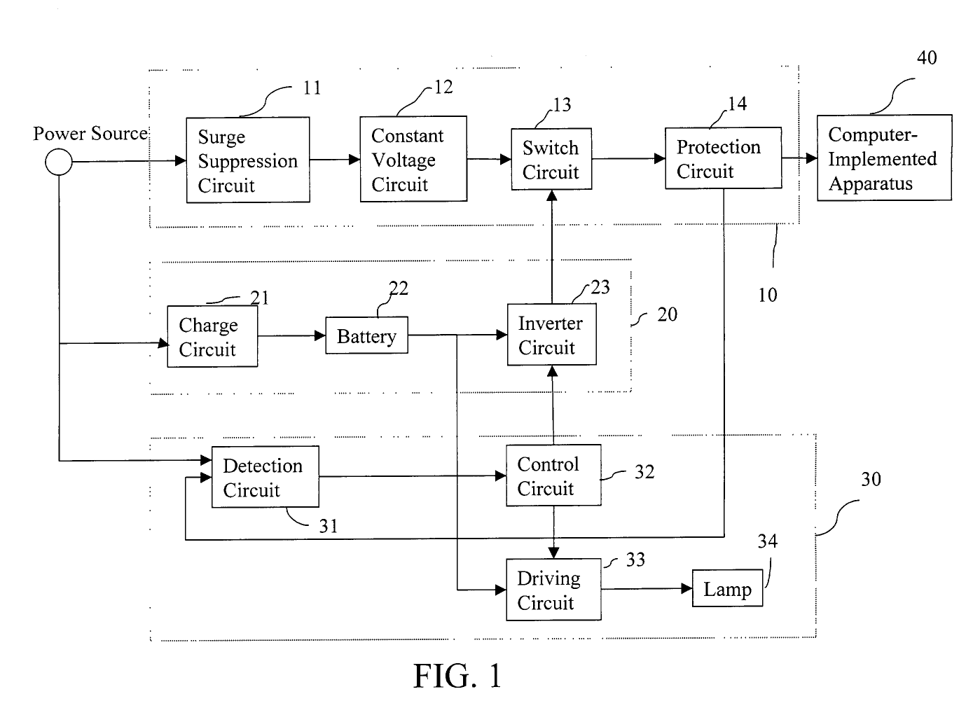

The invention discloses an uninterruptible power supply (UPS) with a built-in lamp. With reference to FIG. 1, the block diagram of the UPS can be divided into three parts. The first part is the regular power unit 10, the second part is the charge circuit 20, and the third part is the illumination circuit 30. When the regular power source is providing electricity normally, clean and stable power is delivered to the computer-implemented apparatus 40 through the regular power unit 10. When a power failure occurs, the charge circuit 20 provides power for the computer-implemented apparatus 40 instead. Meanwhile the illumination unit 30 is activated to light the surroundings such that users is able to do some emergency operations.

The first part of the block diagram, the regular power unit 10, comprises a surge suppression circuit 11, a constant voltage circuit 12, a switch circuit 13, and a protection circuit 14. When the regular power source is operating normally, power is delivered to the computer-implemented apparatus 40 through the regular power unit 10. Wherein the surge suppression circuit 11 filters the incoming power and impulse noise in order to prevent the UPS from an unstable power source. The constant voltage circuit 12 regulates the voltage of the filtered power within a predetermined range to prevent damage to the computer-implemented apparatus 40 due to unstable voltage levels. The switch circuit 13, when power failure occurs switch the power supply from the regular source to the battery 22 of the UPS. The protection circuit 14 is functioning to protect the load (e.g. the computer-implemented apparatus 40) from large output current.

The second part of the block diagram, the charge circuit 20, comprises a charge circuit 21, a battery 22, and a inverter circuit 23. When the regular power source is operating normally, the battery 22 is also charged by the regular power source. When power failure occurs, the inverter circuit 23 transforms the DC power of the battery 22 to AC power which is similar to that of the regular power source. The backup power is then delivered to the computer-implemented apparatus 40 through the switch circuit 13.

Thus the computer-implemented apparatus is powered either by the regular power source or the battery 22. The third part of the block diagram, the illumination circuit 30, comprises a detection circuit 31, a control circuit 32, a driving circuit 33 and a lamp 34. The detection circuit 31 detect the appearance of power failure. If power failure occurs, the detection circuit 31 issues a power interruption signal to the control circuit 32, which then issues an activation signal to the inverter circuit 23. The inverter circuit transforms the DC power of the battery 22 and outputs it as AC power. The switch circuit 13 takes the AC power as an input and switches the delivered power from the regular power source to the backup power. When power failure occurs, the control circuit 32 transmits another activation signal to the driving circuit 33, which then turns on the lamp 34. The lamp 34 lights the surroundings such that users is able to do some emergent operations. The lamp 34 as disclosed by the present invention only turns on when a power failure occurs. It is much different from the well-known emergency lights in the aspects of design and size.

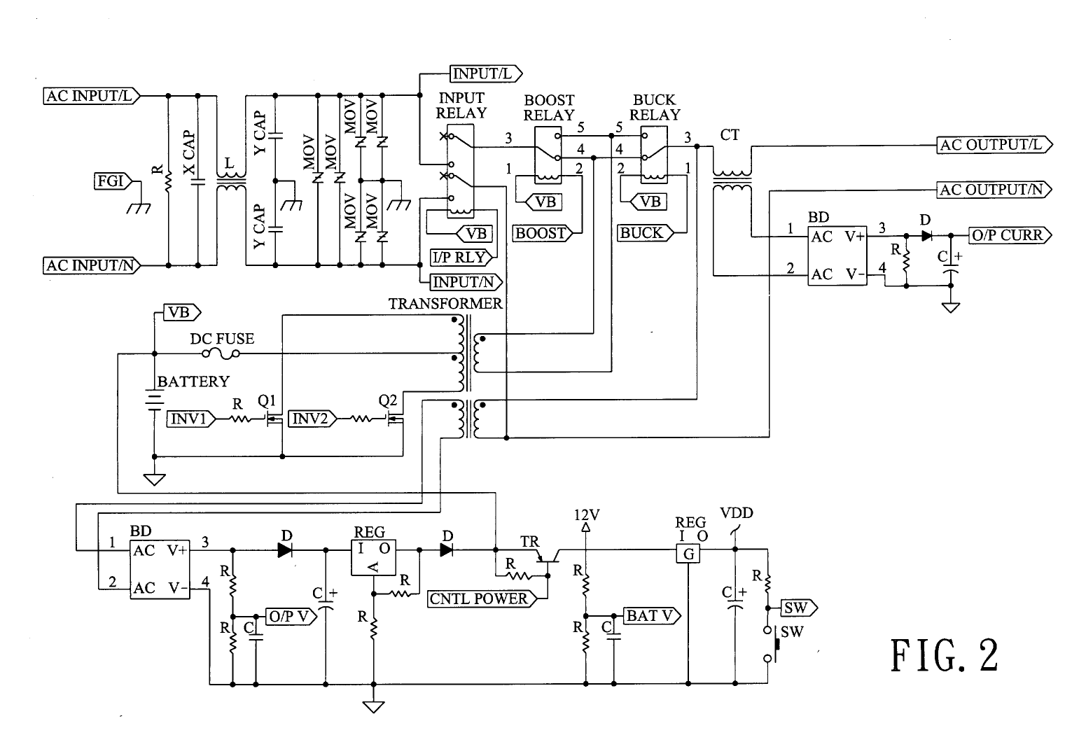

The detection circuit 31 as disclosed by the present invention comprises a plurality of resistors, diodes, capacitors and transistors, as known in FIG. 2 When power failure occurs, the detection circuit 31 issues a power interruption signal to the control circuit 32. The control circuit 32 comprises mainly a micro-controller. A programmable logic IC whose number is ST72215G2 from ST Microelectronics is a preferred embodiment. The power interruption signal is outputted to the I/PV pins of the IC. A computer software controls the output of the activation signal to the inverter circuit 23 and the driving circuit 33. The activation circuit of the inverter circuit 23 is issued from the INV1 and INV2 pins.

The driving circuit 33 of the lamp 34 comprises several capacitors, resistors and three bipolar junction transistors. Upon reception of the activation signal, the driving circuit 33 issues a signal to turn on the light, wherein the light is a cold cathode light.

The UPS with built-in lamp of the present invention provides an emergency power source with an automatically turned on lamp such that users is able to do some emergent operations. The inconvenience of having an alternate light source at hand is much improved by the present invention.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. An uninterruptible power supply (UPS) system with built-in lamp comprising:
a regular power unit, which supplies clean and stable power output by way of regulating the voltage of and filtering the input from the regular power source when it is providing electricity normally comprising:
a surge suppression circuit, which protects the UPS from impulse noise from the regular power source;
a constant voltage circuit, which is connected to the surge suppression circuit and supplies a stable power output;
a switch circuit, which is connected to the constant voltage circuit and switches the power output from the regular source to the backup source from the UPS; and
a protection circuit, which is connected to the switch circuit and determines whether the output current to the load is too large in order to protect the UPS from larger current, which may result in damage to the system;
a charge circuit, which recharges the backup source when the regular power source is providing electricity normally, comprising:
a battery, which is charged by the power source when the regular power source is providing normally;
a charge circuit, which is connected to the battery, charging the battery when the power source is regular provided; and
a inverter circuit, which is connected to the battery, and converts the DC power of the battery to AC power for use as backup power;
an illumination unit, which lights the surroundings using the backup power such that users is able to do some emergent operations, comprising
a detection circuit, for detecting the appearance of power failure and issuing a power interruption signal once power failure occurs;
a control circuit, which is connected to the detection circuit, for transmitting an activation signal to the inverter circuit upon reception of the power interruption signal;
a driving circuit, which is connected to the control circuit and the battery for turning on the lamp upon reception of the activation signal from the control circuit when a power failure occurs; and
a lamp, which is connected to the driving circuit and is turned on by the driving circuit upon reception of the activation signal by the driving circuit.

2. An uninterruptible power supply (UPS) system as claimed in claim 1, wherein the control circuit further comprises a micro-controller.

3. An uninterruptible power supply (UPS) system as claimed in claim 1, wherein the lamp is a cathode light.

4. An illumination unit for the UPS, used to automatically light the surroundings when a power failure occurs and the UPS is providing the power comprising:
a detection circuit, for detecting the appearance of power failure and issuing a power interruption signal once power failure occurs;
a control circuit, which is connected to the detection circuit, for transmitting an activation signal to the inverter circuit upon reception of the power interruption signal, wherein the inverter circuit can then convert the DC power of the battery to AC power;
a driving circuit, which is connected to the control circuit and the battery, for turning on the lamp upon reception of the activation signal from the control circuit when a power failure occurs; and
a lamp, which is connected to the driving circuit and is turned on by the driving circuit upon reception of the activation signal by the driving circuit.

5. An illumination unit for the UPS claimed in claim 4, wherein the detection circuit comprises of a plurality of diodes, several resistors, several capacitors and a bipolar junction transistor.

6. An illumination unit for the UPS claimed in claim 4, wherein the driving circuit comprises of a plurality of resistors, several capacitors, and three bipolar junction transistors.

7. An illumination unit for the UPS claimed in claim 4, wherein the control circuit further comprises a micro0controller.

8. An illumination unit for the UPS claimed in claim 4, wherein the lamp is a cathode light.

9. A driving circuit for a UPS with built-in lamp, comprising of a micro-controller and a driving circuit, wherein the driving circuit turns on the lamp upon reception of the activation signal from the micro-controller when a power failure occurs.
